(19) United States
(12) Patent Application Publication
(10) Pub. No.: US 2004/0156974 A1
(43) Pub. Date: Aug. 12, 2004

(54) Method of making amazake

(76) Inventor: Senya Yamanaka, Ueno-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/726,690

(22) Filed: Dec. 4, 2003

(30) Foreign Application Priority Data
Feb. 10, 2003 (JP) 2003 - 032200

(51) Int. Cl. A23L 1/168

(52) U.S. Cl. 426/618

(57) ABSTRACT

This invention provides a method of making Amazake with using germinated brown rice as a main raw material, adding water to Koji (malted rice) made from this germinated brown rice, making it fermented at fixed temperature and time and crushing or smashing the made Amazake, which makes it possible to contain bran layer and embryo of germinated brown rice which contributes for the health to improve, make it easy to drink and makes it possible for people to effectively absorb the nutrition germinated brown rice contains.

This invention relates to a method of making Amazake with using germinated brown rice as a main raw material which makes it possible to absorb the nutritional component of germinated brown rice by drinking.

In a conventional method of making Amazake which is generally known, as proposed in the Japanese Patent Provisional publication No. 11-196830 official gazette, it is made by using sake lees as a main raw material, dissolving this sake lees with hot water and adding sugar and ginger to them.

By the way, since sake lees used in the conventional method of making Amazake is one left after squeezing Sake (rice wine) in the process of making Japanese Sake (Japanese rice wine), there are few rate of starch content and sugar content as composition of rice. Therefore, it is difficult to make sweet Amazake only by a main raw material and the conventional Amazake is inferior in taste to one made by the present invention.

Furthermore, in another method of making Amazake, it is made by mixing Rice koji with boiled or steamed rice, adding hot water of the desired temperature to this, maintaining this to be fermented between 12 to 24 hours at 50˜60 degrees and mix this fermented on with about three times hot water.

Though such Amazake with using polished rice tastes much better than one with using sake lees as a main raw material, has a high sugar content, is easy to be digested and is acknowledged as alimentation drink, since polished rice used as a main material has lost effective germination and bran layer brown rice contains, Amazake made by polished rice becomes the product which is lacked in an effective ingredient like the above and which has a problem that it could not get various health promotion effect that germination and bran layer give.

Therefore, the purpose of the present invention is providing a method of making Amazake which is easy to swallow without anything left at the mouth and without alien substance sense when drinking, which makes it possible to absorb the nutritional component of bran layer and germination germinated brown rice contains.

Furthermore, another purpose of the invention is providing a method of making nutritious Amazake with including bran layer of germinated brown rice.

Another purpose of the invention is providing a method of making Amazake with an excellent taste as well as sweetness by mixing with Amazake made by using polished rice.

Furthermore, another purpose of the invention is providing a method of making Amazake to make it easy to make germinated brown rice Koji as well as to absorb the nutritional component germinated brown rice contains.

The above-mentioned and the other purposes and specialties of the invention will be more understandable by considering the following explanations.

A method of making Amazake in the invention is characterized in that it is made by adding water to Koji made from germinated brown rice, maintaining this to be converted into sugar between 3 to 18 hours at about 40-70 degrees, crushing or smashing the made Amazake, mixing with adequate Amazake which is made by the above-mentioned Amazake rice as a main material raw and then filling these to a desired sealing container members.

Moreover, the above-mentioned germinated brown rice will be polished with leaving embryo part of brown rice in order to make better Koji and will be polished by removing only scarfskin with leaving bran layer and embryo of brown rice in order to absorb the nutritional component of germinated brown rice.

Amazake made by the method in the present invention is easy to drink without scarfskin and germination of germinated brown rice left at the mouth, which has an effect on a human body by absorption of nutritious germination since the digestive absorption percentage after drinking improves and contributes to promotion of health by drinking.

Also, mixing Amazake of germinated brown rice with Amazake made by using polished rice has also an effect on increasing flavor remarkably.

Furthermore, because of using germinated brown rice polished with leaving bran layer and embryo of brown rice and with removing only scarfskin, nutritive bran layer and germination including minerals contributes to promotion of health remarkably as well as removing scarfskin dissolves the problem that it is difficult to swallow with scarfskin left in the mouth.

A method of the example of the invention with using germinated brown rice as a main raw material consists of the process of adding water to Koji which is made from this germinated brown rice and maintaining this to be converted into sugar with keeping it warm between 3 to 18 hours at about 40˜70 degrees, the process of crushing or smashing the Amazake which is made by this converting into sugar and the process of filling this crushing or smashing Amazake to a desired sealing container members.

Koji of the above germinated brown rice is made by throwing out germinated brown rice for example with electric germination machine as well as by adding Koji fungus (rice bran) to the germinated brown rice which is germinated to be fermented for 30˜50 hours at ambient temperatures.

When crushing germination in the above, for example, it is done by pouring Amazake between a fixed crushing board and a turning crushing board, and when smashing Amazake in the above, it is done by using a mixer.

Also, as sealing container members for the above Amazake, bags of vacuum wrapping and containers for retort food which glues together a lid sheet in the opening of the receptacle body in the heat and so on can be used.

Amazake made like this, because of adding water to Koji made from germinated brown rice, keeping it warm to be converted in to sugar, and crushing or smashing the one converted into sugar, can be drunk without bran layer and germination of germinated brown rice left at the mouth, and the digestive absorption percentage after drinking improves, which brings an effect which is peculiar to germinated brown rice on a human body by absorption of nutritious germination and contributes to promotion of health by drinking.

A method of making of the 2nd example of the invention is characterized by mixing Amazake made by a method of making of the above-mentioned 1st example into Amazake made by an existing method using polished rice as a main raw material, for example, at the suitable ratio 1:1 or 2:1 and so on and then filling these mixed Amazake to a sealing container members.

Amazake made by the method of 2nd example can be drunk without alien substance sense even if scarfskin and germination of germinated brown rice are contained as well as combines a flavor of Amazake using time-honored Japanese polished rice as a main raw material. Then, germinated brown rice used in a method of making of the 1st and 2nd examples is for example better to be the one grown by adopting a method of growing rice plants as proposed by the Japanese patent Application No. 2001-225536 (Patent provisional publication No. 2003-38047 Official Gazette), which brings an excellent medical health improvement effect to the human body as a result of having a good influence on the growth of the rice by both of many elements and small amount elements of the mineral manure in the subtle balance and bringing up rice without destroying a nutritional balance.

Also, germinated brown rice used in a method of making of the above 1st and 2nd examples could be the one polished with leaving an embryo part.

The germinated brown rice polished like this has an advantage that they could obtain an excellent germinated brown rice Koji since Koji fungus breeds actively when it becomes Koji.

As the way of polishing rice with leaving an embryo part of the above-germinated brown rice, it is possible to be polished by germination polished rice machine or adjusting for the pressurization power to decrease when rice is polished by a general polished rice machine.

Also, it is possible to use the one polished to remove only scarfskin with leaving bran layer and embryo of brown rice as germinated brown rice.

Polishing rice which meets a condition like the above can be done by a germination polished rice machine or by adjusting for the pressurization power when rice is polished by a general polished rice machine.

Using germinated brown rice polished to remove only scarfskin with leaving bran layer and embryo of germinated brown rice makes it possible to contribute a health development by eutrophication of bran layer of germinated brown rice which became Koji and by mineral of the germination as well as to drink without alien substance sense by the way of removing scarfskin.

The contrast example Here, make Amazake by using germinated brown rice, mixing rice koji to the germinated brown rice, adding hot water, keeping this warm to be fermented between 12 to 24 hours and mixing this with about three times hot water.

This kind of Amazake has a problem that it is difficult to drink with scarfskin and germination left at the mouth since scarfskin, bran layer and germination of germinated brown rice are mixed as they are.

Also, there is a problem that the nutrition of germinated brown rice cannot be effectively absorbed since the full scarfskin and the full germination are difficult to digest and these are defecated just as they are.

What is claimed is:

1. A method of making Amazake characterized in consisting of the process that it is made by adding water to Koji made by germinated brown rice and keeping this warm to be converted into sugar between 3 to 18 hours at about 40-70 degrees, the process of crushing or smashing the Amazake made by converting into sugar and the process of filling crushed or smashed Amazake to a desired sealing container members.

2. A method of making Amazake characterized in adding water to Koji of germinated brown rice, letting them to be fermented, crushing or smashing this to be Amazake, mixing another Amazake made by polished rice as a main raw material into this Amazake quantitatively and filling these to a desired sealing container members.

3. A method of making Amazake mentioned in the claim 1 or 2 which features to use germinated brown rice polished to leave an embryo part of brown rice as the above-mentioned germinated brown rice.

4. A method of making Amazake mentioned in the claim 1 or 2 which features to use germinated brown rice polished to remove only scarfskin with leaving bran layer and embryo of brown rice as the above-mentioned brown rice.
